(19) United States
(12) Patent Application Publication
(10) Pub. No.: US 2012/0163827 A1
(43) Pub. Date: Jun. 28, 2012

(54) INFRARED REMOTE CONTROL UNIT AND LIGHTING SYSTEM HAVING SAME

(75) Inventors: MIN TAN, Shenzhen City (CN); QIANG GUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/110,009

(22) Filed: May 18, 2011

(30) Foreign Application Priority Data
Dec. 28, 2010 (CN) 201010609034.2

(51) Int. Cl. H04B 10/00

(52) U.S. Cl. 398/106

(57) ABSTRACT

An infrared remote control unit includes an infrared remote control and an infrared processing unit. The infrared remote control includes a keypad and an infrared light emitting diode. The keypad is configured to receive user's input. The infrared light emitting diode is configured to emit infrared light according to the user's input. The infrared processing unit is configured to connect between a lamp and a household power. The infrared processing unit includes an infrared receiver and a processor. The infrared receiver is configured to receive the infrared light emitted from the infrared light emitting diode. The processor is configured to read instructions contained in the infrared light to control the lamp to turn off/on according to the read instructions.

### BACKGROUND

1. Technical Field

The present disclosure relates to an infrared remote control unit and a lighting system having the control unit.

2. Description of Related Art

In daily life, turning off/on the light is manually implemented by depressing button(s). However, it is inconvenient if the button(s) is(are) away from the bed when people have to get up at night.

### BRIEF DESCRIPTION OF THE DRAWINGS

FIG. 1 illustrates a block diagram of a lighting system including an infrared remote control and an infrared processing unit according to a first embodiment, showing the lighting system connected to a household power.

FIG. 2 illustrates a circuit diagram of one embodiment of the infrared remote control of FIG. 1.

FIG. 3 illustrates a circuit diagram of one embodiment of the infrared processing unit of FIG. 1.

FIG. 4 illustrates a block diagram of a lighting system according to a second embodiment.

### DETAILED DESCRIPTION

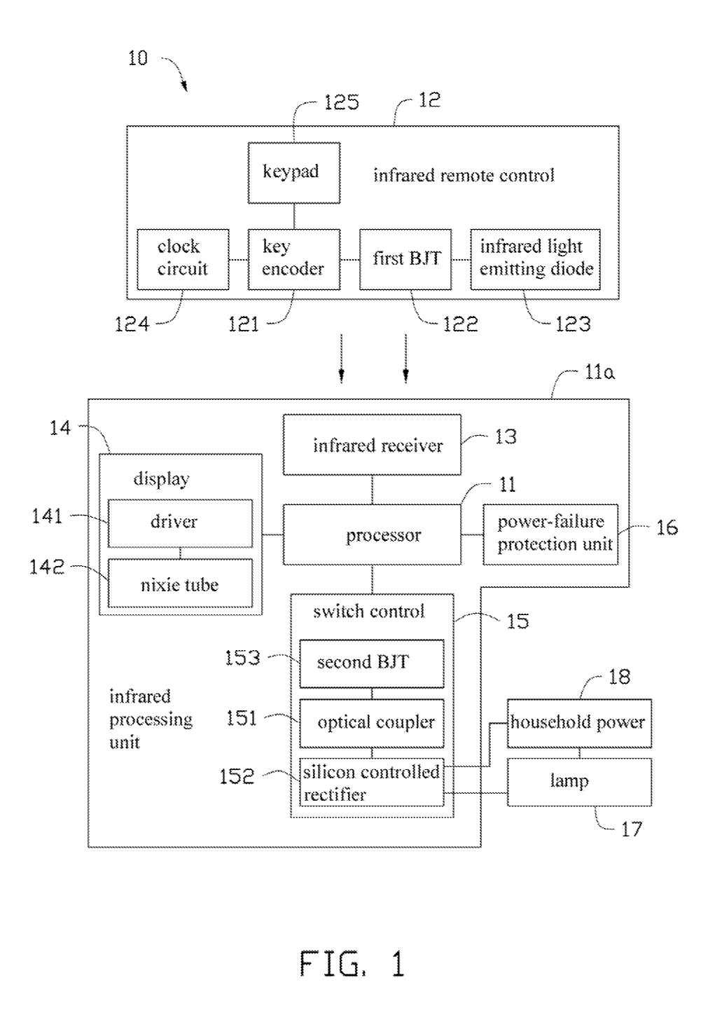

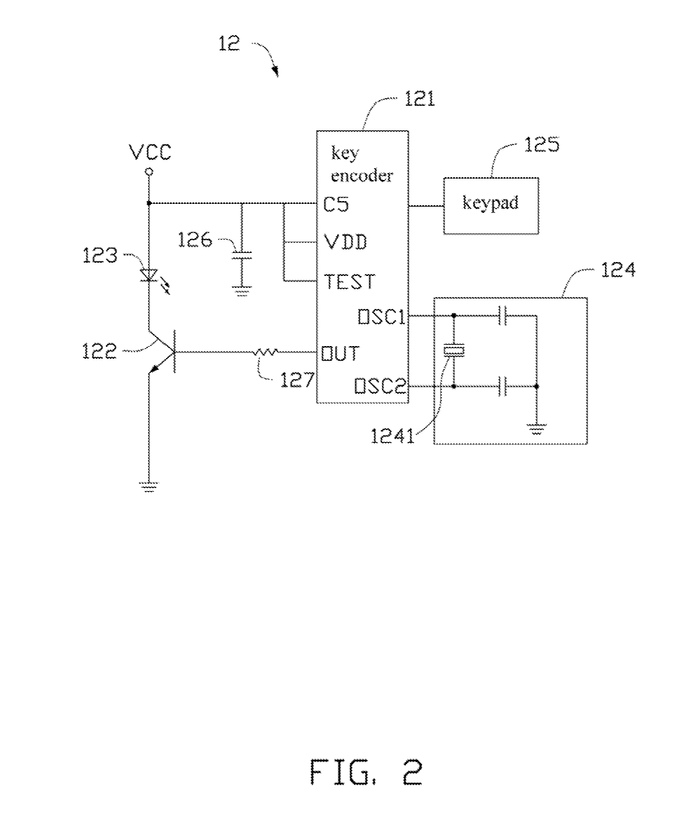

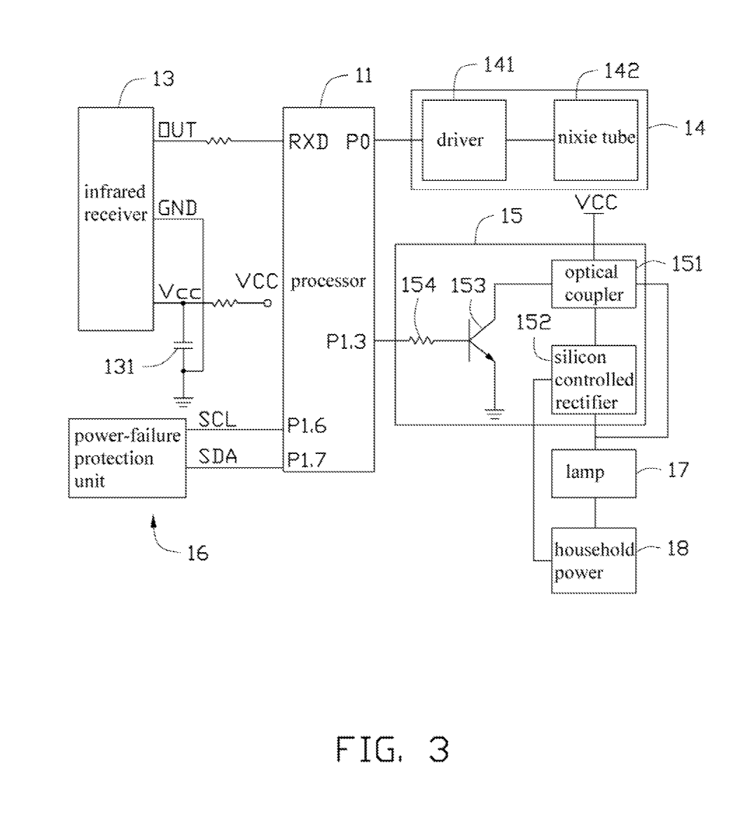

Referring to FIGS. 1 to 3, a lighting system 10, according to a first embodiment, includes an infrared remote control unit and a lamp 17. The infrared remote control unit includes an infrared remote control 12 and an infrared processing unit 11a. The infrared processing unit 11a is connected to the lamp 17 and a household power 18.

The infrared remote control 12 includes a key encoder 121, a first bipolar junction transistor (BJT) 122, an infrared light emitting diode 123, a clock circuit 124, and a keypad 125.

The key encoder 121 may be any available commercial encoders, such as the SANYO LC7461. The keypad 125 may include keys for adjusting brightness of the lamp 17, an on/off key, a timing key, and/or a reset key, etc. For example, the keypad 125 includes a number of keys, each of which can implement a different brightness level of the lamp 17.

A base of the first bipolar junction transistor 122 is connected to an OUT pin of the key encoder 121 (an output pin for transmit LED drive) via a first resistor 127. An emitter of the first bipolar junction transistor 122 is grounded. A collector of the first bipolar junction transistor 122 is connected to a cathode of the infrared light emitting diode 123. When a key of the keypad 125 is depressed, the key encoder 121 triggers the first bipolar junction transistor 122, thereby driving the infrared light emitting diode 123 to emit infrared light correspondingly.

An anode of the infrared light emitting diode 123 is connected to a power supply terminal VCC. A C5 pin, a VDD pin, and a TEST pin of the key encoder 121 are connected to a node between the anode of the infrared light emitting diode 123 and the power supply terminal VCC. A capacitor 126 is connected between the node and ground. The capacitor 126 is capable of wave-filtering to stabilize voltage applied to the infrared light emitting diode 123.

The clock circuit 124 includes an oscillator 1241 having a frequency of 455 KHz, in one example. Two terminals of the oscillator 1241 are connected to an OSC1 pin and an OSC2 pin of the key encoder 121, respectively. The OSC1 pin and the OSC2 pin of the key encoder 121 are input and output pins for ceramic resonator-used oscillation. A frequency used for infrared communication is about 37.9 KHz, which is obtained by dividing 455 KHz by twelve.

The infrared processing unit 11a includes an infrared receiver 13, a processor 11, a display 14, a switch control 15, and a power-failure protection unit 16.

The infrared receiver 13 may be a TSOP1838 infrared receiver, in one example. The processor 11 may be an ATMEL AT89C2051 microcomputer, in one example. An output pin of the infrared receiver 13 is connected to a RXD (serial input port) pin of the processor 11. A GND pin of the infrared receiver 13 is grounded. A Vcc pin of the infrared receiver 13 is connected to a power supply terminal VCC. The Vcc pin of the infrared receiver 13 is also connected to ground via a capacitor 131 to perform wave filtering.

The display 14 includes a driver 141 and a nixie tube 142. The driver 141 may be a TEXAS INSTRUMENTS SN74HC574, in one example. The driver 141 is connected to a P0 pin of the processor 11. The nixie tube 142 is a common-cathode nixie tube. The processor 11 reads a timing signal, indicating duration after which a predetermined function is performed, output from the infrared remote control 12 and drives the driver 141 to control the nixie tube 142 to display the duration. It is to be understood that in alternative embodiments, the driver 141 may be connected to a P1 pin or a P2 pin of the processor 11.

An oscillator frequency of the processor 11 is about 11.0592 Mhz, in one example. The processor 11 is configured to read instructions contained in the infrared light emitted from the infrared receiver 13 and save the instructions in the power-failure protection unit 16. The power-failure protection unit 16 includes an electrically erasable and programmable read only memory (EEPROM), such as an ATMEL AT24C01, in one example. The AT24C01 provides 1024 bits of serial electrically erasable and programmable read only memory organized as 128 words of 8 bits each. The AT24C01 is accessed via a 2-wire serial interface. The AT24C01 includes a serial data (SDA) pin and a serial clock input (SCL) pin. The SCL pin is used to positive edge clock data into each EEPROM device and negative edge clock data out of each device. The SDA pin is bidirectional for serial data transfer and is open-drain driven and may be wire-ORed with any number of other open-drain or open collector devices. The SDA pin is normally pulled high with an external device. Data on the SDA pin may change only during SCL low time periods. Data changes during SCL high periods will indicate a start or stop condition as defined below. START CONDITION: a high-to-low transition of SDA with SCL high is a start condition which must precede any other command STOP CONDITION: a low-to-high transition of SDA with SCL high is a stop condition which terminates all communications and after a read sequence, the stop command will place the EEPROM in a standby power mode.

The switch control 15 includes an optical coupler 151, a silicon controlled rectifier 152, a second bipolar junction transistor 153 and a second resistor 154. The base of the second bipolar junction transistor 153 is connected to a P1.3 pin of the processor 11 via the second resistor 154. The optical coupler 151 is a MOTOROLA MOC3081, in one example. The collector of the second bipolar junction transistor 153 is connected to a cathode of the optical coupler 151. An anode of the optical coupler 151 is connected to a power supply terminal VCC. A first main terminal of the optical coupler 151 is connected to the live wire of the household power 18 via the lamp 17.

The silicon controlled rectifier 152 is a bidirectional thyristor (TRIAC), in one example. A gate of the rectifier 152 is connected to a second main terminal of the optical coupler 151. A first terminal T1 of the rectifier 152 is connected to the live wire of the household power 18 via the lamp 17. A second terminal T2 of the rectifier 152 is connected to the ground wire of the household power 18. When the base of the second bipolar junction transistor 153 is pulled to logic 1 by the processor 11, the second bipolar junction transistor 153 is turned on, thereby activating the optical coupler 151. Then the rectifier 152 is turned on. Therefore, the household power 18 turns on the lamp 17. To adjust the brightness of the lamp 17, a brightness adjustment key is pressed. The processor 11 may output a pulse-width-modulation (PWM) signal to the switch control 15 in response to the depressed key, therefore adjusting the average value of voltage (and current) fed to the lamp 17.

In use, a user may press an on key, the infrared remote control 12 sends an infrared light accordingly. The infrared receiver 13 receives the infrared light. The processor 11 reads instructions contained in the infrared light and then turns on the second bipolar junction transistor 153. Therefore, the lamp 17 is turned on accordingly. Thus, it is convenient to turn on/off the lamp 17 in daily life.

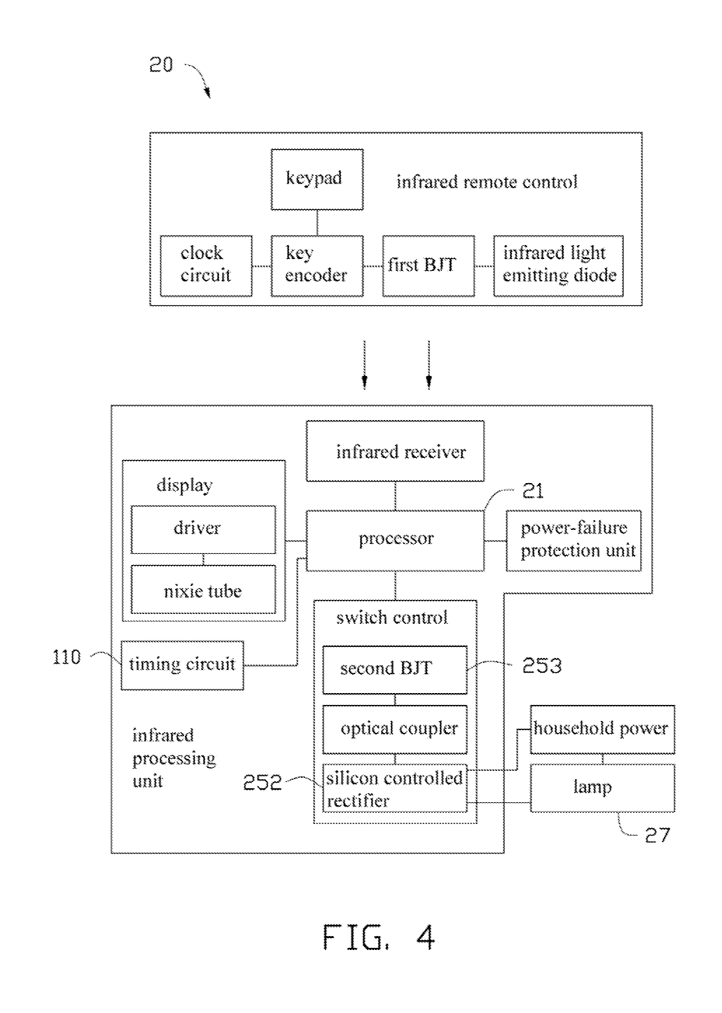

Referring to FIG. 4, a lighting system 20, according to a second embodiment, is shown. The difference between the lighting system 20 and the lighting system 10 of the first embodiment is that the lightening system 20 further includes a timing circuit 110. The timing circuit 100 is connected to a processor 21. At a predetermined time, the timing circuit 110 triggers the processor 21 to turn on a bipolar junction transistor 253. A silicon controlled rectifier 252 is turned on accordingly, thereby turning on a lamp 27. The timing circuit 110 may be any available commercial timing circuit. Thus, it is convenient to control the lamp 27 according to a schedule.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An infrared remote control unit for controlling on and off of a lamp, comprising:
an infrared remote control, comprising a keypad and an infrared light emitting diode, the keypad configured to receive user input, the infrared light emitting diode configured to emit infrared light according to the user input; and
an infrared processing unit configured to connect between the lamp and a household power, the infrared processing unit comprising an infrared receiver and a processor, the infrared receiver configured to receive the infrared light emitted from the infrared light emitting diode, the processor configured to read instructions contained in the infrared light to control the lamp to turn off/on according to the read instructions.

2. The infrared remote control unit of claim 1, wherein the infrared processing unit comprises a power-failure protection unit, the power-failure protection unit configured to save the instructions.

3. The infrared remote control unit of claim 2, wherein the infrared processing unit comprises a switch control, the switch control configured to selectively connect the lamp to the household power according to the processor.

4. The infrared remote control unit of claim 3, wherein the switch control comprises a bipolar junction transistor, a resistor, an optical coupler, and a silicon controlled rectifier, a base of the bipolar junction transistor being connected to the processor via the resistor, the collector of the bipolar junction transistor being connected to a cathode of the optical coupler, an anode of the optical coupler being connected to a power supply terminal, a first main terminal of the optical coupler configured to be connected to the live wire of the household power via the lamp, a gate of the silicon controlled rectifier being connected to a second main terminal of the optical coupler, a first terminal of the silicon controlled rectifier configured to be connected to the live wire of the household power via the lamp, a second terminal of the silicon controlled rectifier configured to be connected to the earth wire of the household power.

5. The infrared remote control unit of claim 3, wherein the infrared processing unit comprises a display, the display comprising a driver and a nixie tube, the driver being connected to the processor and configured to receive control signals from the processor, the nixie tube being connected to the driver and configured to display digitals according to the control signals.

6. The infrared remote control unit of claim 1, wherein the infrared remote control comprises a key encoder and a bipolar junction transistor connected to the key encoder, the key encoder being connected to the keypad and configured to activate the infrared light emitting diode to emit the infrared light using the bipolar junction transistor.

7. The infrared remote control unit of claim 6, wherein a base of the bipolar junction transistor is connected to the key encoder, a collector of the bipolar junction transistor is connected to a cathode of the infrared light emitting diode, and an anode of the infrared light emitting diode is connected to a power supply terminal.

8. The infrared remote control unit of claim 7, wherein the infrared remote control comprises a clock circuit configured to provide a frequency used for infrared communication.

9. A lighting system, comprising:
a lamp; and
an infrared remote control unit, comprising:
an infrared remote control, comprising a keypad and an infrared light emitting diode, the keypad configured to receive user input, the infrared light emitting diode configured to emit infrared light according to the user input; and
an infrared processing unit configured to connect between the lamp and a household power, comprising an infrared receiver and a processor, the infrared receiver configured to receive the infrared light emitted from the infrared light emitting diode, the processor configured to read instructions contained in the infrared light to control the lamp to turn off/on according to the read instructions.

10. The lighting system of claim 9, wherein the infrared processing unit comprises a power-failure protection unit, the power-failure protection unit configured to save the instructions.

11. The lighting system of claim 10, wherein the infrared processing unit comprises a switch control, the switch control configured to selectively connect the lamp to the household power according to the processor.

12. The lighting system of claim 11, wherein the switch control comprises a bipolar junction transistor, a resistor, an optical coupler, and a silicon controlled rectifier, a base of the bipolar junction transistor being connected to the processor via the resistor, the collector of the bipolar junction transistor being connected to a cathode of the optical coupler, an anode of the optical coupler being connected to a power supply terminal, a first main terminal of the optical coupler configured to be connected to the live wire of the household power via the lamp, a gate of the silicon controlled rectifier being connected to a second main terminal of the optical coupler, a first terminal of the silicon controlled rectifier configured to be connected to the live wire of the household power via the lamp, a second terminal of the silicon controlled rectifier configured to be connected to the earth wire of the household power.

13. The lighting system of claim 11, wherein the infrared processing unit comprises a display, the display comprising a driver and a nixie tube, the driver being connected to the processor and configured to receive control signals from the processor, the nixie tube being connected to the driver and configured to display digitals according to the control signals.

14. The lighting system of claim 9, wherein the infrared remote control comprises a key encoder and a bipolar junction transistor connected to the key encoder, the key encoder being connected to the keypad and configured to activate the infrared light emitting diode to emit the infrared light using the bipolar junction transistor.

15. The lighting system of claim 14, wherein a base of the bipolar junction transistor is connected to the key encoder, a collector of the bipolar junction transistor is connected to a cathode of the infrared light emitting diode, and an anode of the infrared light emitting diode is connected to a power supply terminal

16. The lighting system of claim 15, wherein the infrared remote control comprises a clock circuit configured to provide a frequency used for infrared communication.
